(19) United States
(12) Patent Application Publication
(10) Pub. No.: US 2011/0225091 A1
(43) Pub. Date: Sep. 15, 2011

(54) METHODS, SYSTEMS, AND COMPUTER READABLE MEDIA FOR TRANSACTIONAL FRAUD DETECTION USING WIRELESS COMMUNICATION NETWORK MOBILITY MANAGEMENT INFORMATION

(76) Inventors: Franco Plastina, Cary, NC (US); Robert J. Tinsley, Chapel Hill, NC (US); Peter J. Marsico, Chapel Hill, NC (US)

(21) Appl. No.: 13/047,287

(22) Filed: Mar. 14, 2011

Related U.S. Application Data
(60) Provisional application No. 61/313,697, filed on Mar. 12, 2010.

(51) Int. Cl. G06Q 40/00

(52) U.S. Cl. 705/44

(57) ABSTRACT

Methods, systems, and computer readable media for detecting transactional fraud can involve, for a transaction associated with a first transaction location and account holder, receiving a request for mobile location information associated with the account holder. Mobile location information associated with the account holder may then be obtained, wherein the mobile location information is derived from mobility management signaling messages or other data associated with a mobile communication device used by the account holder. The mobile location information associated with the account holder can then be provided to the requestor. The mobile location information may be compared against the first transaction location to determine, at least in part, whether the transaction is fraudulent.

### PRIORITY CLAIM

This application claims the benefit of U.S. Provisional Patent Application Ser. No. 61/313,697, filed Mar. 12, 2010, the disclosure of which is incorporated herein by reference in its entirety.

### TECHNICAL FIELD

The subject matter disclosed herein relates generally to data communications and fraud detection systems and methods. More particularly, the subject matter disclosed herein relates to methods, systems, and computer readable media for detecting fraudulent or potentially fraudulent activity associated with geographically un-constrained transactions, such as credit and debit card transactions.

### BACKGROUND

Identifying potentially fraudulent transactions associated with geographically un-constrained transactions, such as credit and debit card transactions is desirable. As used herein, the term “geographically un-constrained transaction” refers to any type of transaction that may be readily performed at different geographic locations. For example, a credit card may be used (e.g., swiped) at a point-of-sale device associated with a first retail merchant in a first location at 10 am and subsequently used again at a point-of-sale device associated with a second retail merchant in a second location, perhaps hundreds of miles from the first location, at 1 pm. Such credit card usage behavior would not be uncommon or unusual. There may be use scenarios, however, in which such card usage behavior is the result of fraudulent activity, such as a stolen physical credit card, or stolen card number and security CCV number. In such situations, the mere locations and times of transactions (or groups of transactions) often do not provide enough information to determine whether the transaction is an authorized one.

Accordingly, it would be desirable to enable better and more reliable identification of potential instances of fraud with regard to such geographically un-constrained transactions.

### SUMMARY

Methods, systems, and computer readable media for detecting fraudulent or potentially fraudulent activity associated with geographically un-constrained transactions are provided. In one aspect, a method for facilitating detection of transactional fraud is provided. The method may comprise, for a transaction associated with a first transaction location and account holder, receiving a request for mobile location information associated with the account holder. The method may then further comprise obtaining mobile location information associated with the account holder, wherein the mobile location information is derived from mobility management signaling messages or other data associated with a mobile communication device used by the account holder, and providing the mobile location information associated with the account holder to the requestor.

In another aspect, a method for detecting transactional fraud is provided. This method may comprise, in response to detecting a transaction associated with a first transaction location and account holder, requesting, from a mobile network operator, mobile location information associated with the account holder or a mobile device associated with the account holder. The method may then further comprise receiving the mobile location information associated with the account holder, and comparing the received mobile location information against the first transaction location to determine, at least in part, whether the transaction is fraudulent.

In yet another aspect, a system for detecting transactional fraud is provided. The system may comprise a mobile location information access application (MLIA) embodied in a non-transitory computer readable medium, wherein the MLIA may itself include means for obtaining mobile location information derived from mobility management messages or other data associated with a mobile communication device and means for providing the mobile location information to a requestor for determining whether a transaction is fraudulent.

The subject matter described herein for detecting fraudulent or potentially fraudulent activity associated with geographically un-constrained transactions can be implemented in software in combination with hardware and/or firmware. In one exemplary implementation, the subject matter described herein can be implemented using a non-transitory computer readable medium having stored thereon executable instructions that when executed by the processor of the computer control the computer to perform steps. Exemplary computer readable media suitable for implementing the subject matter described herein include disk memory devices, chip memory devices, application specific integrated circuits, and programmable logic devices. In addition, a computer readable medium that implements the subject matter described herein may be located on a single device or computing platform or may be distributed across plural devices or computing platforms.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIGS. 1 and 2 are message flow diagrams illustrating a system for detecting transactional fraud using a signal transfer point (STP) with integrated mobile location information access application (MLIA) functionality according to an embodiment of the presently disclosed subject matter;

FIGS. 3 and 4 are message flow diagrams illustrating a system for detecting transactional fraud using an STP with integrated MLIA functionality and a “lightweight” home location register (HLR) according to an embodiment of the presently disclosed subject matter;

FIG. 5 is a network diagram illustrating a system for detecting transactional fraud using a “lightweight” HLR according to an embodiment of the presently disclosed subject matter;

FIG. 6 is a message flow diagram illustrating a system for detecting transactional fraud using a stand-alone MLIA application according to an embodiment of the presently disclosed subject matter;

FIG. 7 is a message flow diagram illustrating a system for detecting transactional fraud using a stand-alone MLIA application and a “lightweight” HLR that is integrated with a network monitoring system according to an embodiment of the presently disclosed subject matter;

FIG. 8 is a network diagram illustrating a system for detecting transactional fraud using a “lightweight” HLR that is integrated with a network monitoring system according to an embodiment of the presently disclosed subject matter;

FIG. 9 is a message flow diagram illustrating a system for detecting transactional fraud using a Diameter router with integrated MLIA functionality according to an embodiment of the presently disclosed subject matter;

FIG. 10 is a message flow diagram illustrating a system for detecting transactional fraud using a Diameter router with integrated MLIA functionality and a “lightweight” home subscriber server (HSS) according to an embodiment of the presently disclosed subject matter;

FIG. 11 is a network diagram illustrating a system for detecting transactional fraud using a Diameter router and a “lightweight” HSS according to an embodiment of the presently disclosed subject matter;

FIG. 12 is a message flow diagram illustrating a system for detecting transactional fraud using a Diameter router as a stand-alone MLIA application according to an embodiment of the presently disclosed subject matter;

FIG. 13 is a network diagram illustrating a system for detecting transactional fraud using a Diameter router and a “lightweight” HSS that is integrated with a network monitoring system according to an embodiment of the presently disclosed subject matter;

FIG. 14 is a message flow diagram illustrating a system for detecting transactional fraud using a presence server according to an embodiment of the presently disclosed subject matter;

FIG. 15 is a message flow diagram illustrating a system for detecting transactional fraud using a Diameter router in communication with both a presence server and an HSS according to an embodiment of the presently disclosed subject matter; and

FIG. 16 is a message flow diagram illustrating a system for detecting transactional fraud using an accounting and billing function or module according to an embodiment of the presently disclosed subject matter.

### DETAILED DESCRIPTION

The present subject matter provides methods, systems, and computer readable media for detecting fraudulent or potentially fraudulent activity associated with geographically un-constrained transactions, such as credit and debit card transactions. Specifically, the present subject matter provides methods, systems, and computer readable media for utilizing mobility management information associated with a wireless communications network (e.g., GSM, IS-41, SIP, IMS, LTE, etc.) to identify fraudulent or potentially fraudulent transactions.

For instance, when a geographically un-constrained transaction is executed, a requestor may request mobile location information associated with the authorized user of the account. The requestor may be a bank, financial institution, credit card institution or other interested party wishing to use location information about a mobile device and/or mobile subscriber to identify transaction fraud. For example, in the case of a credit card transaction, the requestor may request mobile location information associated with the card holder.

Mobility management information may be obtained from a wireless network and may include explicit or implicit location information associated with a mobile subscriber or a mobile device (e.g., a GSM/IS-41/SIP/LTE/IMS-based mobile phone) that is believed to be associated with the transaction in question. If a location of the mobile subscriber or mobile device can be determined from the mobility management information, the location can be compared to the location of the transaction (e.g., the location of a retailer, point-of-sale device, cellular telephone, or automated teller machine). This comparison may be used by the requestor as an indication of a likelihood of fraud with regard to the transaction.

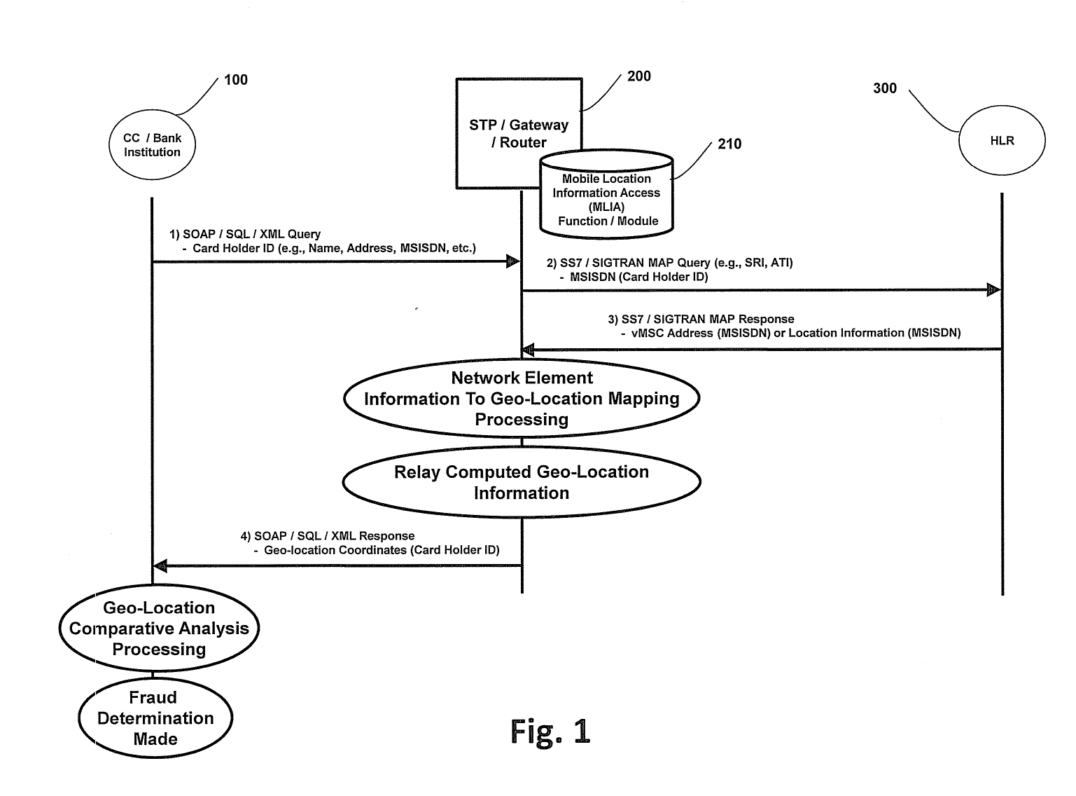

In one embodiment of the present invention shown in FIG. 1, for example, a requestor 100 may request mobile location information from a signal transfer point (STP), generally designated 200, which may be adapted to receive and route messages (e.g., SS7 MTP, IETF SIGTRAN). STP 200 may have access to a mobile location information access (MLIA) module or application, generally designated 210, that is associated with or has access to mobility management resources in the wireless network or has such a module or application integrated therein. Specifically, MLIA 210 may be adapted to obtain the requested mobile location information associated with the target mobile device or mobile subscriber and to return location information to requestor 100. For example, MLIA 210 may access a database or table that maps card holder identifiers to mobile network subscriber and/or device identifiers. For instance, Table 1 below provides an example of mapping of Card Holder ID information to a mobile station integrated services digital network (MSISDN) entry:

TABLE 1

| Card Holder Name | Address | MSISDN |
|---|---|---|
| Joseph Q. Tekelec | 3 Big Rd., Cary, NC, 27511 | 9195551234 |

Thus, STP 200 is adapted to receive a query from requestor 100 (e.g., a credit card, banking, or other institution) that wishes to obtain location information for a mobile device and/or mobile subscriber that is believed to be associated with a transaction of interest. The query may be formatted according to various protocols including, but not limited to, simple object access protocol (SOAP), SQL, ODBC, or XML. The query may include information that can be used to identify the card holder/subscriber associated with the transaction of interest. As necessary, MLIA 210 may translate the card holder information into identifiers recognized by the mobile network operator. Exemplary card holder information may include, but is not limited to, an MSISDN identifier, an international mobile subscriber identity (IMSI) identifier, a subscriber name, a subscriber address, and/or a private subscriber ID known only between requestor 100 and the mobile network operator. Exemplary mobile device identifiers may include, but are not limited to, an IMEI, or IMSI. Exemplary mobile subscriber identifiers may include, but are not limited to, an MSISDN, a SIP URI, an IP address, or a telephone number.

MLIA 210 may then generate a query (e.g., SS7/SIGTRAN SRI, ATI) requesting location information for the mobile network subscriber and/or device from a home location register (HLR), generally designated 300, which may contain such information. MLIA 210 may receive a response from HLR 300 to the query and extract the provided location information. Exemplary implicit location information may include, but is not limited to, GSM/IS41 serving mobile switching center (MSC) identity information (e.g., routing number, IP network address, point code address), LTE serving mobility management entity (MME) identity or SGSN identity information (e.g., FQDN, IP address, URI, network address), SIP proxy server identity information (e.g., URI, IP address, network address), IMS serving or proxy call session control function (CSCF) identify information, WiFi access point identification information (e.g., FQDN, IP address), LTE eNode B identification information, GSM/IS41 BTS/BSC identification information, GSM/IS41 Location Area Code (LAC) information, tracking area information, visited network identification information (e.g., DIAMETER visited_PLMN_ID, etc.), GSM/IS41/LTE/IMS Cell ID information, or geo-location coordinate information (e.g., GPS coordinate information, longitude, latitude).

As necessary, MLIA 210 may be adapted to translate the provided implicit location information (e.g., serving network switch ID, radio cell ID, access point ID) into an associated geo-location coordinate and to provide the geo-location coordinate information to requestor 100. Exemplary explicit location information may include, but is not limited to, physical map coordinate or geo-information information such as GPS coordinate information, or Cartesian coordinate information. For instance, Table 2 below provides an example of mapping of SS7 network information to geo-location coordinates. Such coordinate information may be obtained from the mobile device, it may be generated by the network, or some combination of the two.

TABLE 2

| MSC ID | LAC/Cell ID | Geo-Location Coordinates |
|---|---|---|
| ATT_MSC1 | — | N 37 degrees 43.69, W 97 |
| | | degrees 28.39 |
| — | 1030/639E | N 35 degrees 42.49, W 57 |
| | | degrees 18.30 |
| ATT_MSC2 | 1030/639F | N 40 degrees 42.49, W 60 |
| | | degrees 18.30 + 2 mile |
| | | radius |

Requestor 100 may use the mobile device and/or subscriber location information obtained from the wireless network to compare against known geo-location information corresponding to the transaction being scrutinized, such as the location of a retailer, point-of-sale device, automatic teller machine, computer initiating the transaction, or the like. For example, a transaction may be flagged or identified as a potential fraudulent transaction if the location information associated with the mobile device and/or mobile subscriber does not coincide with the geo-location information corresponding to the retailer associated with the transaction being scrutinized.

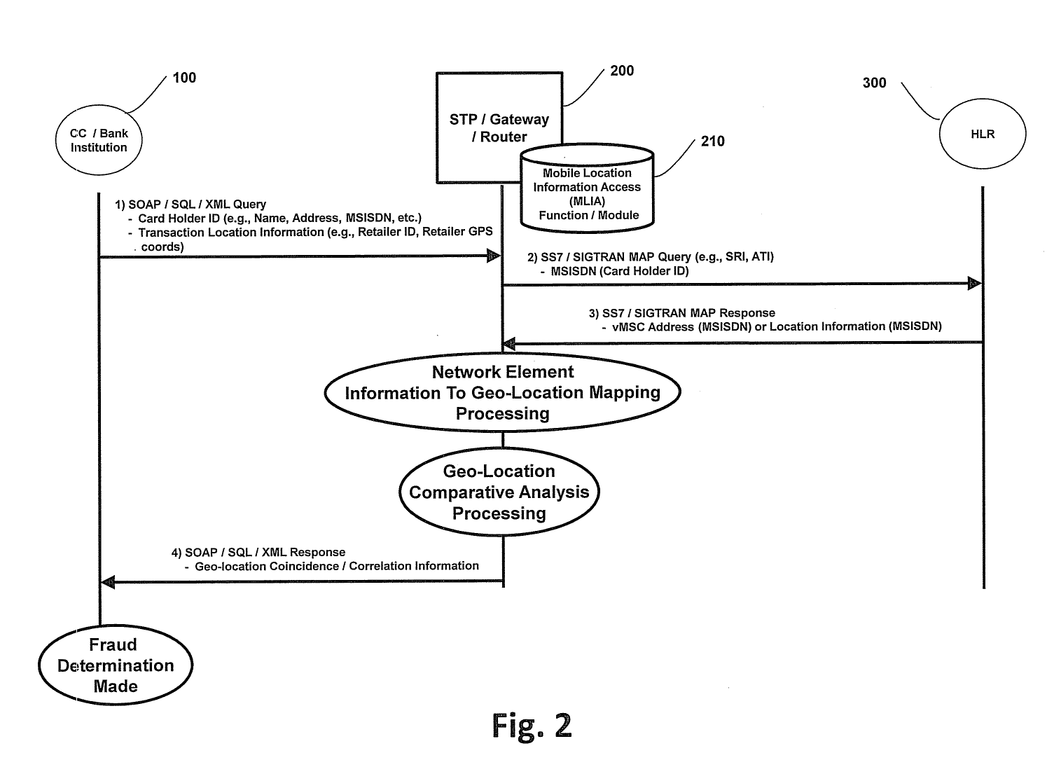

Alternatively, as shown in FIG. 2, requestor 100 may provide the geo-location coordinates of the retailer/point-of-sale terminal associated with the transaction of interest to MLIA 210. MLIA 210 may analyze this retailer/point-of-sale terminal geo-location information in combination with the mobile subscriber and/or mobile device geo-location coordinates in order to gain insight into the likelihood that the transaction of interest is fraudulent. In this arrangement, MLIA 210 may respond to the query from requestor 100 with an indicator of the difference between the mobile subscriber and retailer/point-of-sale terminal geo-location coordinates, or MLIA 210 may respond with an indicator of the likelihood that the transaction of interest is fraudulent (e.g., 1=fraud unlikely, 10=fraud likely)

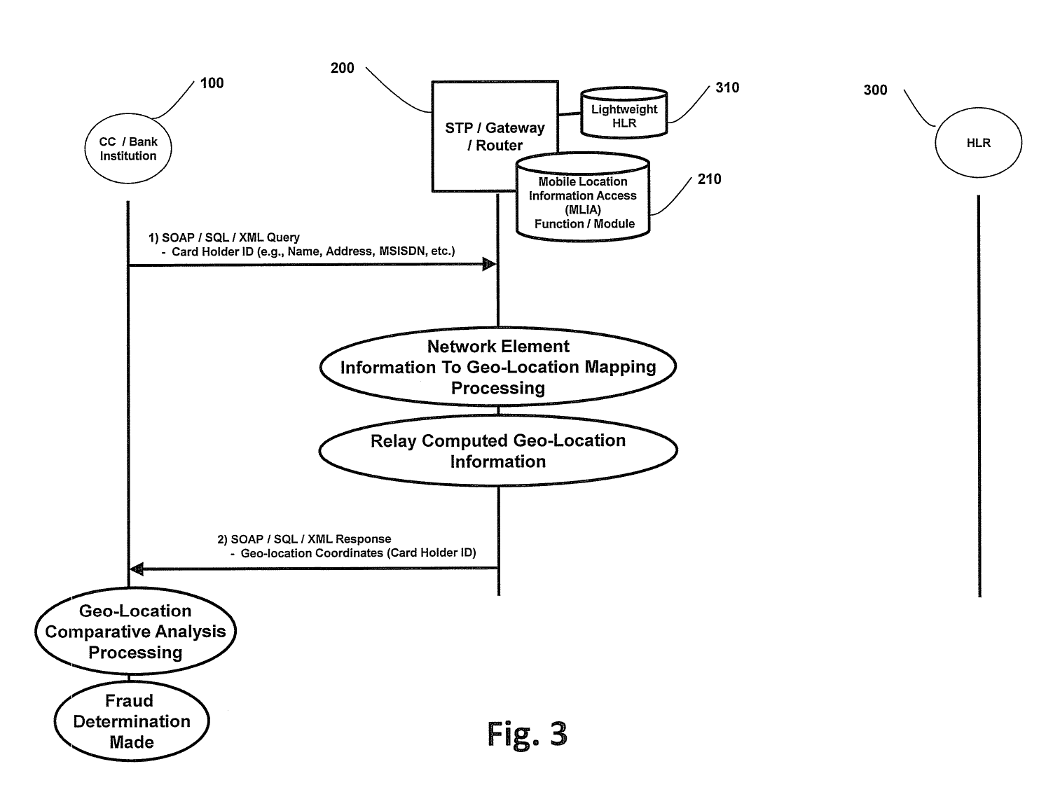

In another embodiment shown in FIG. 3, STP 200 may include or have access to a lightweight HLR 310 that does not contain complete subscriber profile information, but instead contains only a subset of subscriber information, including subscriber location information. In this configuration, lightweight HLR 310 may be tightly integrated with STP 200, and as such MLIA 210 does not need to generate an external HLR query (e.g., SS7/SIGTRAN SRI, ATI) requesting location information for the mobile network subscriber and/or device. Instead, MLIA 210 is able to access data from lightweight HLR 310 internally and thereby obtain the necessary location information.

As necessary, MLIA 210 may translate the provided location information into physical geo-location coordinates (e.g., GPS coordinates). In one embodiment, for instance, MLIA 210 may return the geo-location coordinates to requestor 100. Requestor 100 may then use this geo-location information to compare against the geo-location coordinates of the retailer/point-of-sale terminal in order to gain insight into the likelihood that the transaction of interest is fraudulent.

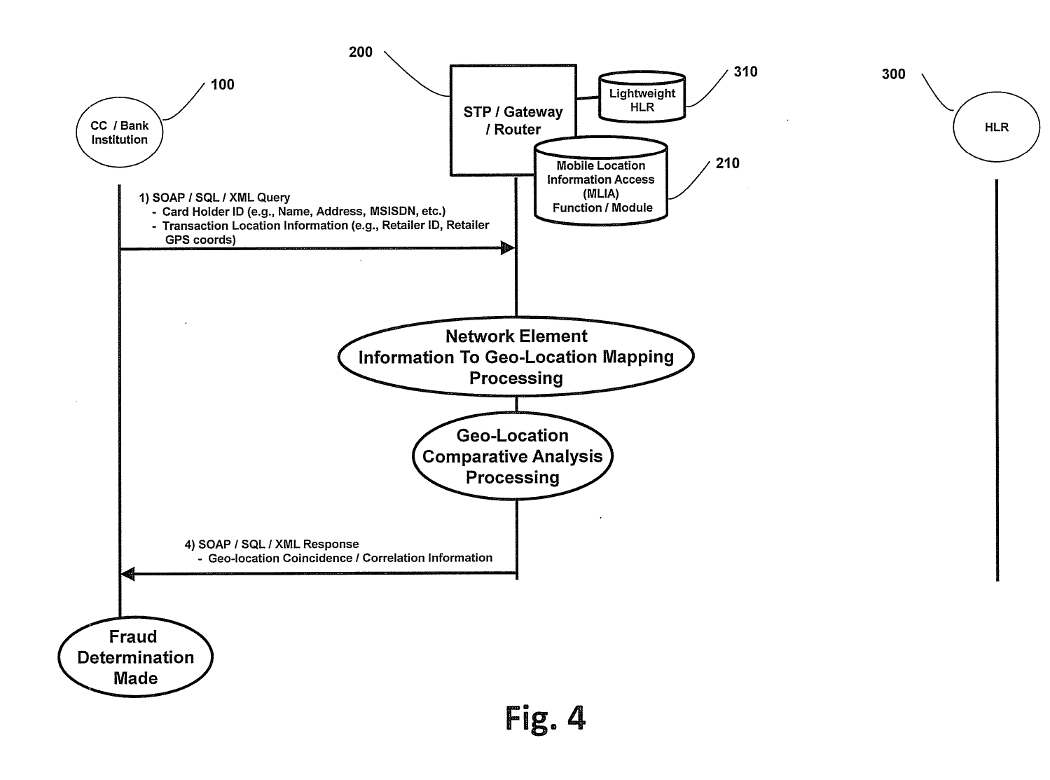

Alternatively, as shown in FIG. 4, requestor 100 may provide the geo-location coordinates of the retailer/point-of-sale terminal associated with the transaction of interest to MLIA 210. MLIA 210 may use this retailer/point-of-sale terminal geo-location information to compare against the mobile subscriber and/or mobile device geo-location coordinates in order to gain insight into the likelihood that the transaction of interest is fraudulent. As before, in this configuration, MLIA 210 may respond to the query from requestor 100 with an indicator of the difference between the mobile subscriber and retailer/point-of-sale terminal geo-location coordinates, or MLIA 210 may respond with an indicator of the likelihood that the transaction of interest is fraudulent (e.g., 1=fraud unlikely, 10=fraud likely, etc.).

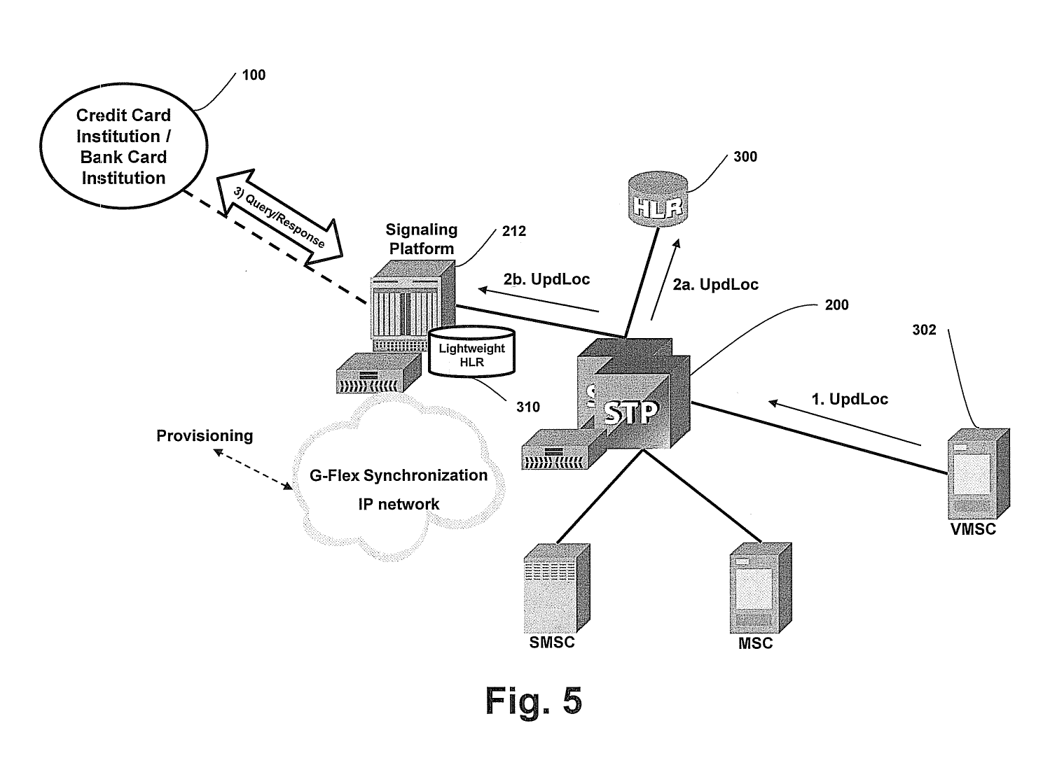

Regardless of where the location comparison is performed, a system having lightweight HLR 310 for subscriber location information can incorporated into a network provisioning system as shown in FIG. 5. In this configuration, where subscriber location information is normally routed from a visited mobile switching center (VMSC) 302 to HLR 300 by STP 200, a copy of this normal message flow is also routed to a signaling platform 212 (e.g., Tekelec Eagle XG) for collection by lightweight HLR 310. Thus, when requestor 100 queries lightweight HLR 310 for the subscriber location information, HLR 300 does not need to be accessed. It will be appreciated that in this manner, STP 200 with its integrated lightweight HLR 310 may be adapted to shield resources of a network operator's primary “heavyweight” HLR 300 from such “fraud detection” type query traffic.

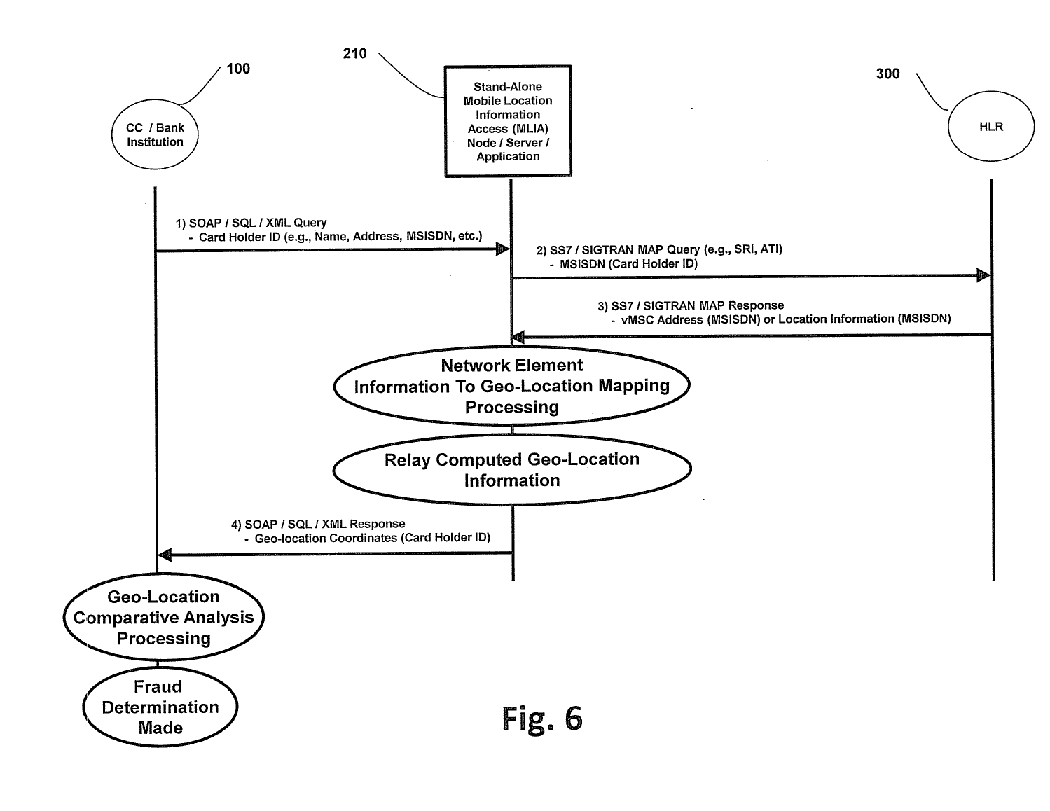

In another embodiment shown in FIG. 6, MLIA 210 may be a stand-alone module or application and may be used to receive requests from requestor 100 that wishes to obtain location information for a mobile device and/or mobile subscriber that is believed to be associated with a credit, debit, or other transaction of interest. This stand-alone version of MLIA 210 can be used in a network system in which stand-alone MLIA 210 generates an HLR query (e.g., SS7/SIGTRAN SRI, ATI) requesting location information for the mobile network subscriber and/or device, and stand-alone MLIA 210 receives a response to the HLR query and extracts the provided location information (e.g., serving MSC_ID, LAC, Cell_ID, subscriber geo-location info).

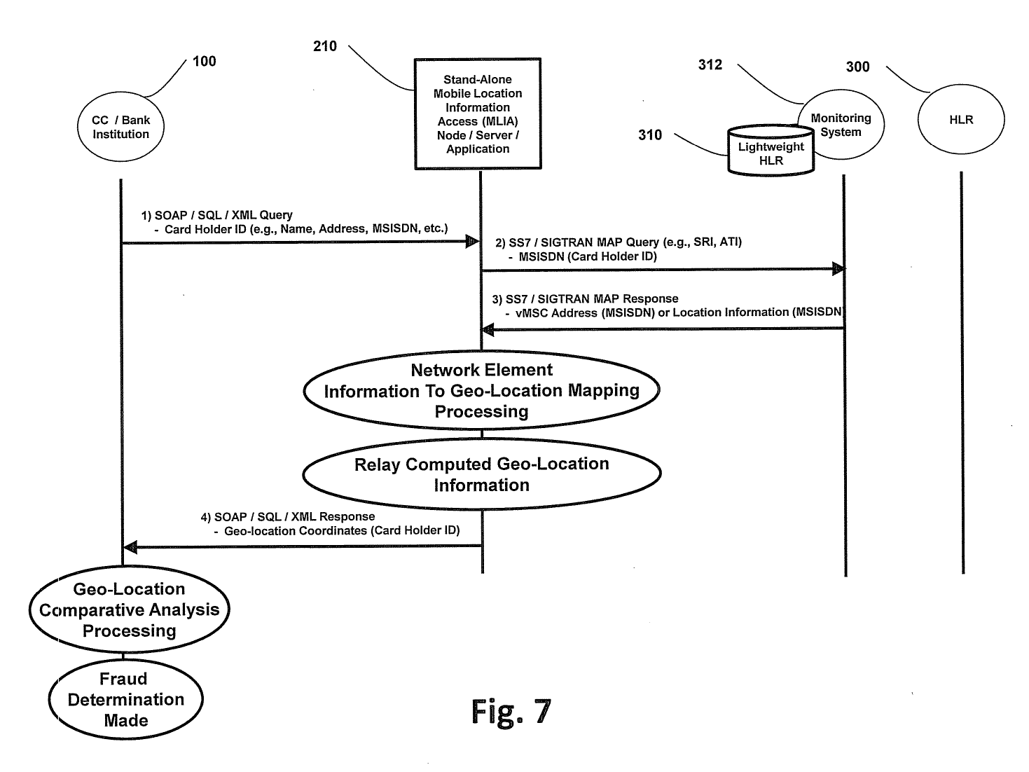

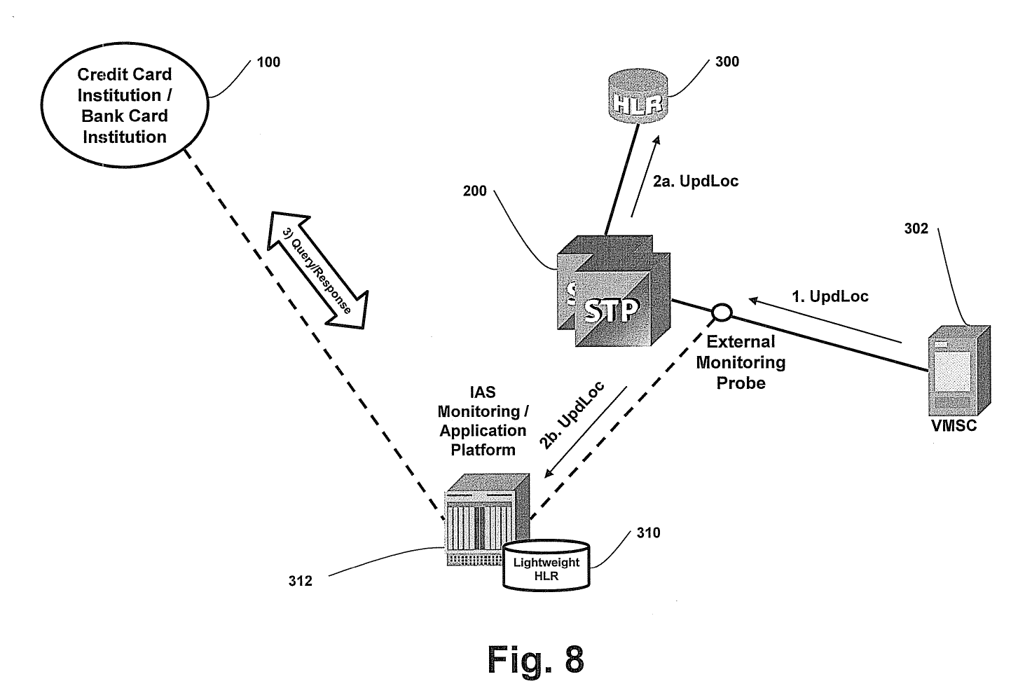

Alternatively, in the embodiment shown in FIG. 7, stand-alone MLIA 210 includes or has access to a lightweight HLR 310 that does not contain complete subscriber profile information, but instead contains a smaller subset of subscriber information, including subscriber location information. In this configuration, lightweight HLR 310 may be tightly integrated with a network monitoring system 312 that is adapted to provision and maintain data in lightweight HLR 310. Specifically, as shown in FIG. 8, where subscriber information from VMSC 302 is normally routed to HLR 300 by STP 200, this normal message flow can be monitored by an external monitoring probe. When this message flow includes location information, a copy of this message flow is also routed to lightweight HLR 310 via monitoring system 312.

In this embodiment, stand-alone MLIA 210 may generate an external HLR query (e.g., SS7/SIGTRAN SRI, ATI) requesting location information for the mobile network subscriber and/or device. Stand-alone MLIA 210 may then receive a response to the query to lightweight HLR 310 and extract the provided location information (e.g., serving MSC_ID, LAC, Cell_ID, subscriber geo-location info). As necessary, stand-alone MLIA 210 may translate the provided location information into physical geo-location coordinates (e.g., GPS coordinates).

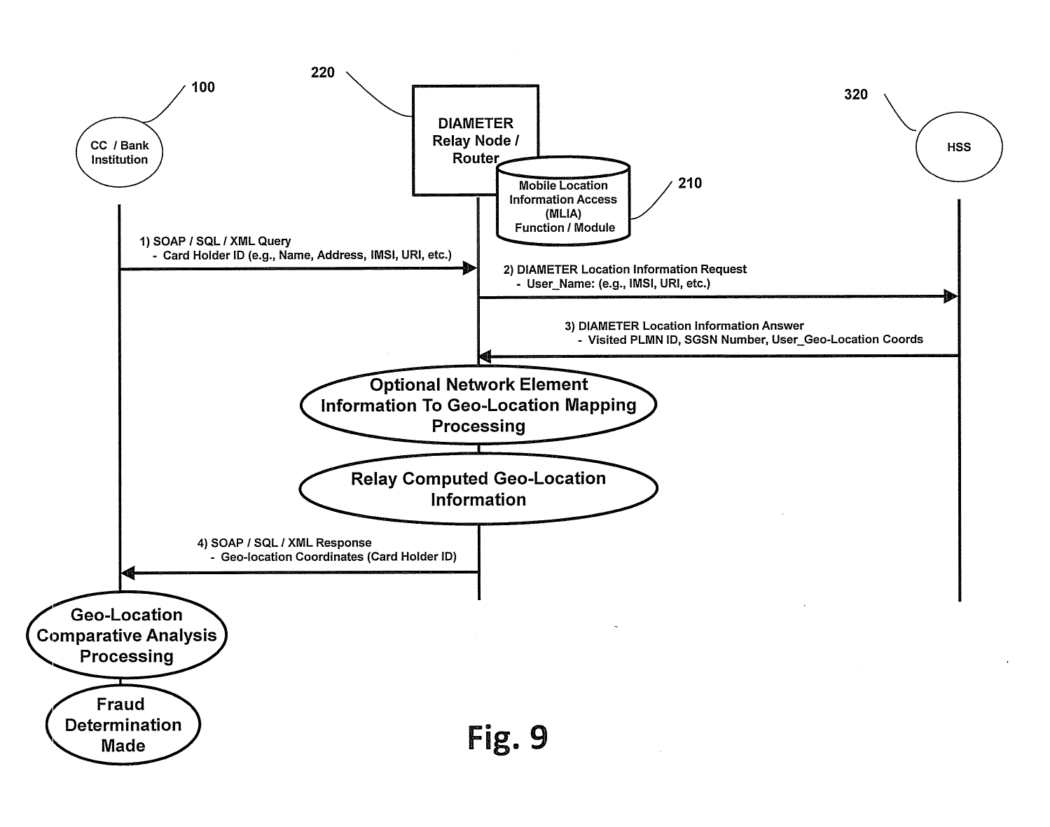

In another embodiment shown in FIG. 9, a Diameter relay node or router, generally designated 220, can provide integrated MLIA functionality for use in the systems and methods described herein. In this configuration, Diameter router 220 may be adapted to receive a query (e.g., Diameter, SOAP, SQL, XML) from requestor 100 that wishes to obtain location information for a mobile device and/or mobile subscriber that is believed to be associated with a transaction of interest. The query may include information that can be used to identify the card holder/subscriber associated with the transaction of interest (e.g., name, address, IMSI, URI). Similarly to the systems and methods discussed above, Diameter router 220 may translate the card holder information into identifiers recognized by the mobile network operator as necessary. For instance, Table 3 below provides an example of mapping of card holder ID information to Diameter user names:

TABLE 3

| Card Holder Name | Address | URI |
|---|---|---|
| Joseph Q. Tekelec | 3 Big Rd., Cary, NC, 27511 | JQT@ATT.com |

Diameter router 220 may then generate a query requesting location information for the mobile network subscriber and/or device from a home subscriber server (HSS), generally designated 320, which may contain such information. In this configuration, the query to HSS 320 may include user name information (e.g., IMSI, URI) that can be used to identify the card holder/subscriber associated with the transaction of interest. HSS 320 may respond with a location information answer, which may include information regarding visited PLMN ID, SGSN Number, and/or user geo-location coordinates. Diameter router 220 may provide the location information to requestor 100. For instance, Table 4 below provides an example of mapping of LTE/IMS network information to geo-location coordinates:

TABLE 4

| | Tracking Area/PLMN ID/ | |
|---|---|---|
| MME ID | LAC/RAC/Cell ID | Geo-Location Coordinates |
| ATT_MME1 | — | N 37 degrees 43.69, W 97 |
| | | degrees 28.39 |
| — | 1030/639E | N 35 degrees 42.49, W 57 |
| | | degrees 18.30 |

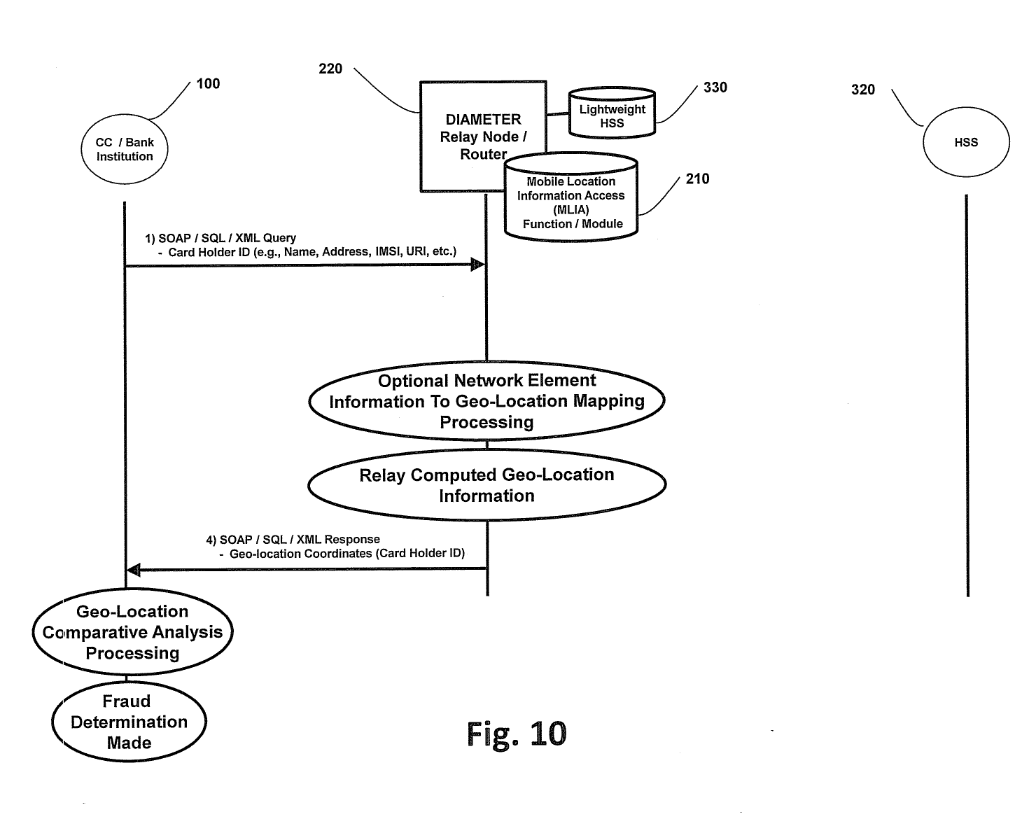

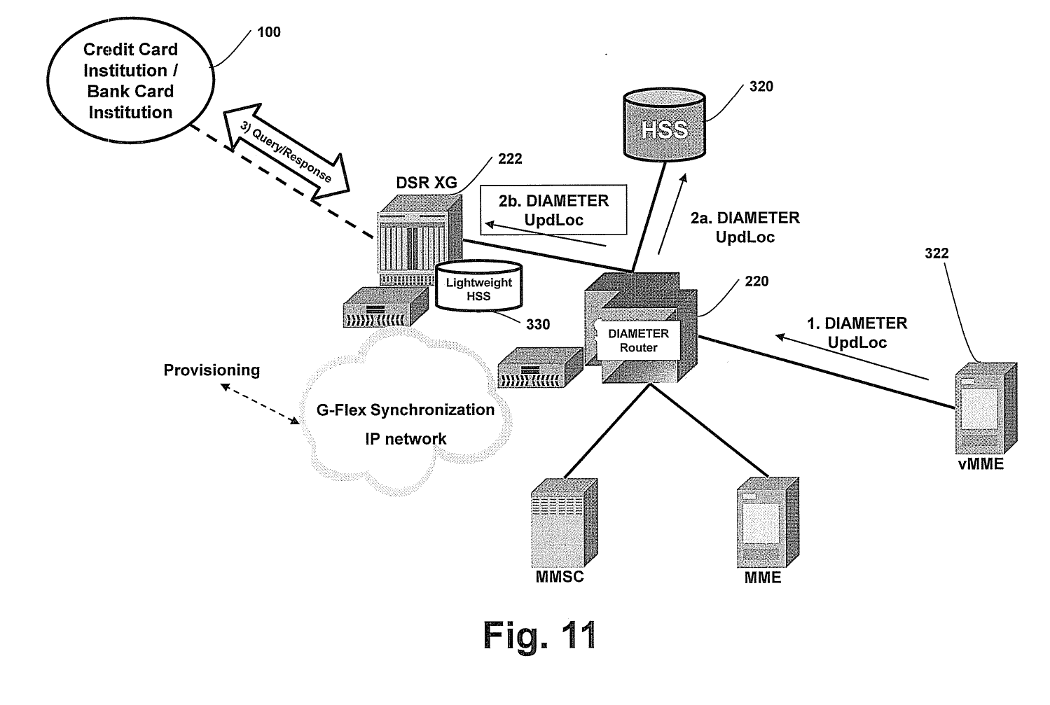

In a similar embodiment shown in FIG. 10, Diameter router 220 having integrated MLIA functionality may include or have access to a lightweight HSS 340 that does not contain complete subscriber profile information, but instead contains only a subset of subscriber information, including subscriber location information. In this configuration, Diameter router 220 need not generate an external query requesting location information for the mobile network subscriber and/or device. Rather, Diameter router 220 may be adapted to access lightweight HSS 340 data internally and thereby obtain the necessary location information. As shown in FIG. 11, for instance, where subscriber location information is normally routed from a visited mobility management entity (VMME) 322 to HSS 320 by Diameter router 220, a copy of this normal message flow may also be routed to a signaling platform 212 for collection by lightweight HSS 330. Thus, when requestor 100 queries lightweight HSS 330 for the subscriber location information, HSS 320 does not need to be accessed.

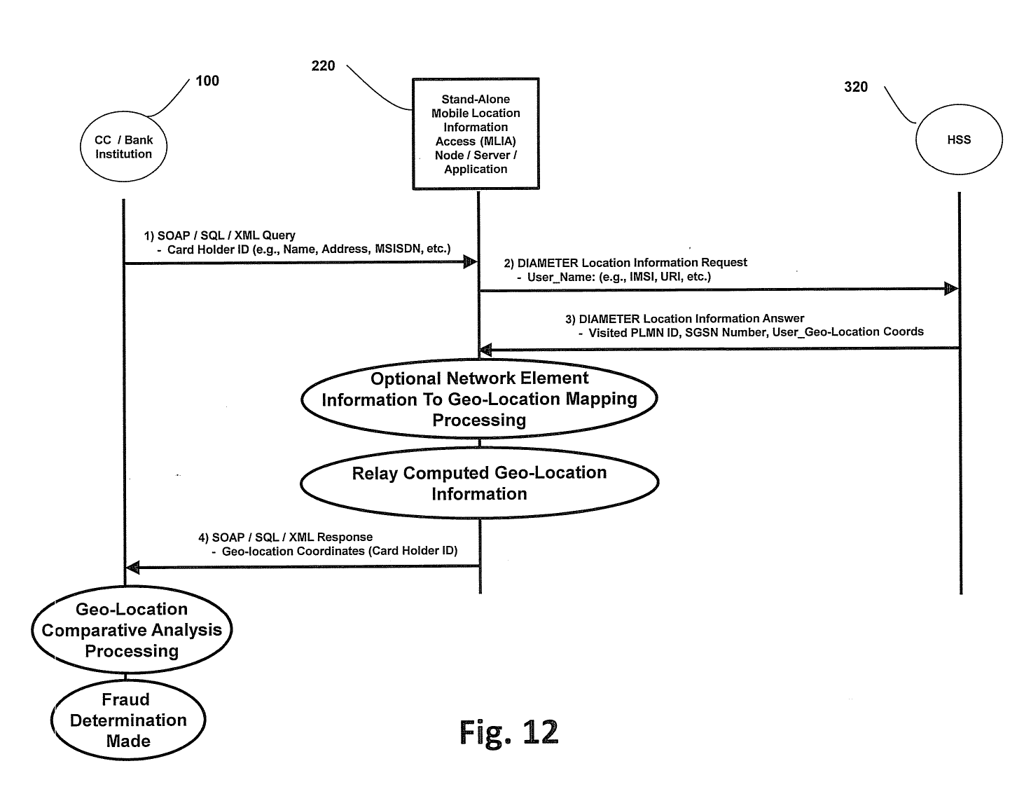

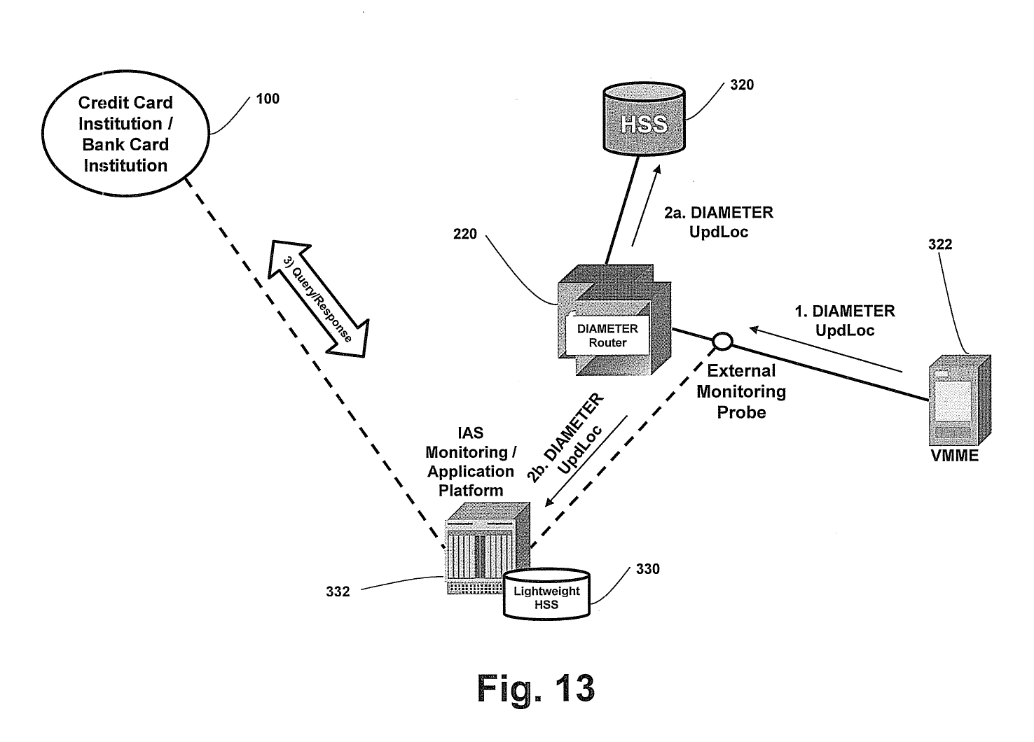

In another embodiment shown in FIG. 12, Diameter router 220 may serve as a stand-alone MLIA application that may be used communicate with both requestor 100 that wishes to obtain location information for a mobile device and/or mobile subscriber that is believed to be associated with a transaction of interest and HSS 320 that may contain location information for the mobile network subscriber and/or device. Specifically, as shown in FIG. 13, where subscriber information from VMME 322 is normally routed to HSS 320 by Diameter router 220, this normal message flow can be monitored by an external monitoring probe. When this message flow includes location information, a copy of this message flow is also routed to lightweight HSS 330 via a monitoring system 332.

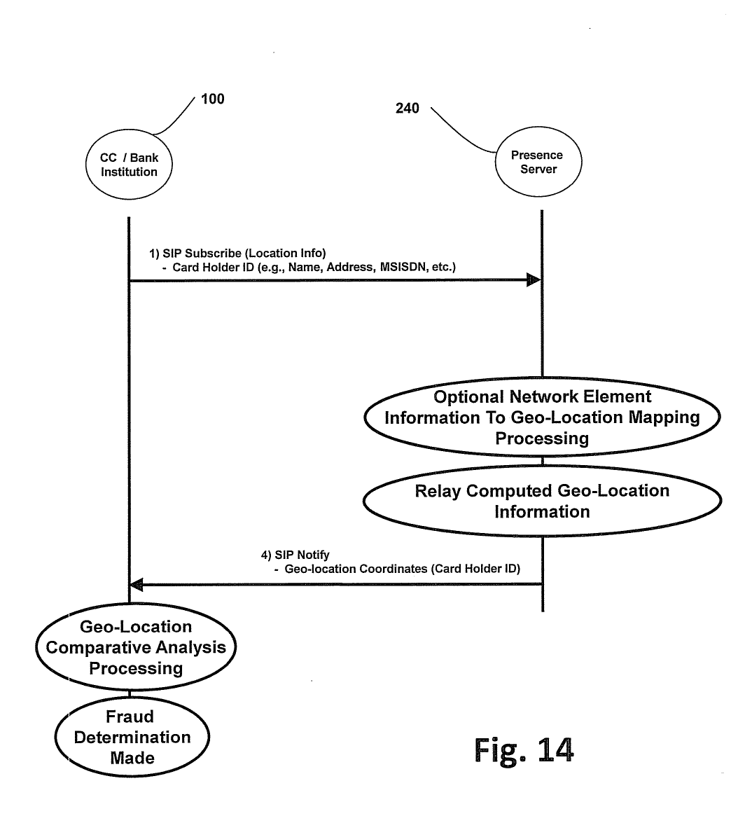

In yet another embodiment shown in FIG. 14, a presence server 230 can be used to provide geo-location coordinates to requestor 100. In this configuration, requestor 100 sends an SIP subscribe request to presence server 230, which may have already gathered presence information from one or more providers. The request may include information that can be used to identify the card holder/subscriber associated with the transaction of interest (e.g., name, address, MSISDN). Presence server 230 may then reply with location information (e.g., geo-location coordinates) associated with the subscriber identified by the original request.

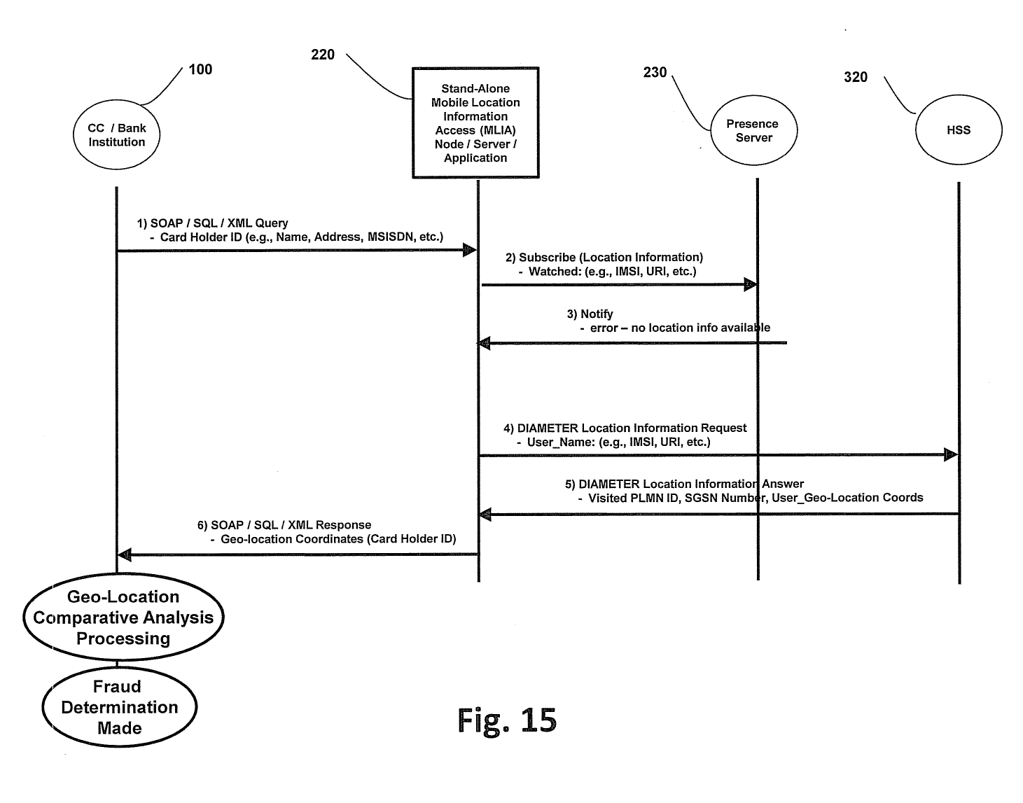

In another embodiment, the use of presence server 230 can be incorporated in parallel with a system that may also communicate with an HLR or HSS. For instance, as shown in FIG. 15, a stand-alone Diameter router 220 may be provided in communication with both presence server 230 and HSS 320. Diameter router 220 may be adapted to first attempt to retrieve and subsequently provide subscriber location information from presence server 230, such as by providing the mobile location information to watchers who subscribe to a financial transaction participant. If presence server 230 is unable to provide the requested subscriber location information, however, then Diameter router 220 may query HSS 320 to obtain the subscriber and/or mobile device location information.

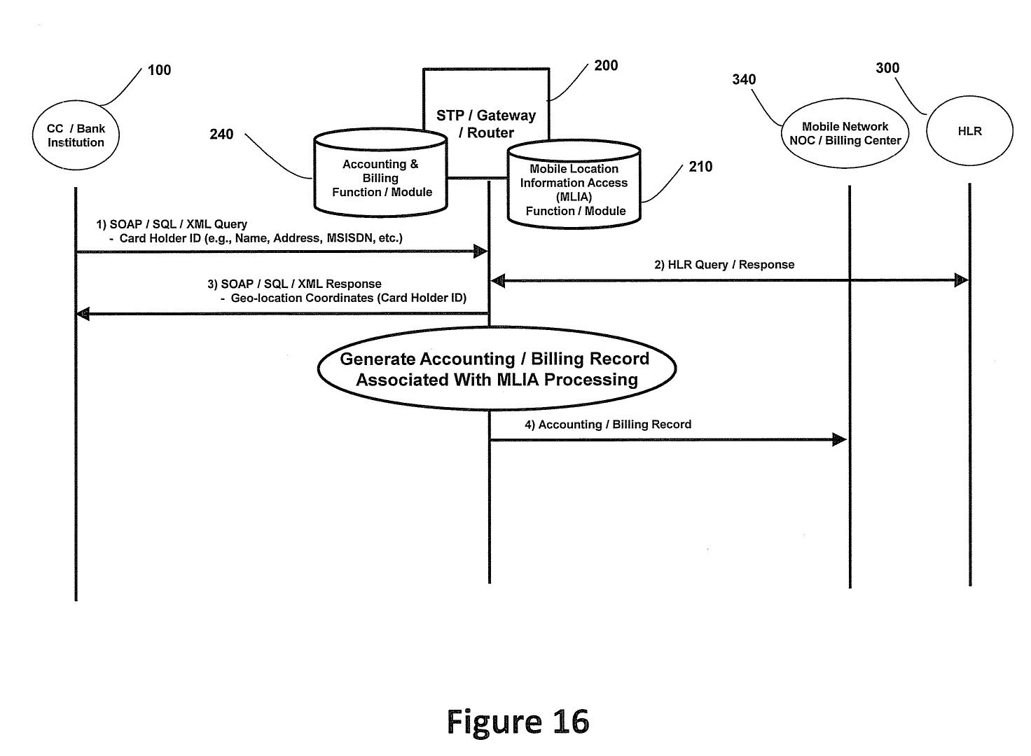

In still another embodiment shown in FIG. 16, an STP 200 having access to an MLIA 210 may further have access to an accounting and billing function or module, generally designated 240. In this configuration, in addition to providing subscriber location information (e.g., geo-location coordinates) to requestor, STP 200 can further generate an accounting/billing record associated with MLIA processing. For instance, Table 5 below provides an example of accounting and billing record data that contains information about a particular MLIA query. This accounting/billing record may be forwarded to a mobile network operations/billing center, generally designated 340.

TABLE 5

| | | Mobile | Serving | |
|---|---|---|---|---|
| | | Subscriber/ | Mobile | |
| Date/Time | | Mobile Device | Location | Location Info |
| Stamp | Card Holder ID | ID | Register | Provided |
| 2/17/2010, | Joseph Q. | 9194605500 | HLR_1 | N 37 degrees |
| 23:10:23 | Tekelec | | | 43.69, W 97 |
| | | | | degrees 28.39 |

Again, while the present invention has been extensively described herein with respect to embodiments that collocate the inventive fraud detection at a routing node (e.g., STP, Diameter router), the embodiments of the present invention may also be implemented in stand-alone network elements or platforms other than such signaling message routers.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A method for facilitating detection of transactional fraud, the method comprising:
for a transaction associated with a first transaction location and account holder, receiving a request for mobile location information associated with the account holder;
obtaining mobile location information associated with the account holder, wherein the mobile location information is derived from data associated with a mobile communication device used by the account holder; and
providing the mobile location information associated with the account holder to the requestor.

2. The method of claim 1 wherein the data associated with a mobile communication device comprises mobility management signaling messages.

3. The method of claim 1 wherein providing the mobile location information comprises providing geo-location coordinates of the mobile communication device.

4. The method of claim 1 comprising:
comparing the transaction location information and the mobile location information; and
providing an indication of a likelihood of fraud to the requestor.

5. The method of claim 4 wherein providing an indication of a likelihood of fraud includes notifying the requestor that fraud is likely in response to determining that a difference exists between the point of sale location and the mobile location information.

6. The method of claim 1 comprising generating an accounting record associated with the mobile location information.

7. The method of claim 1 wherein the transaction comprises a credit or debit card transaction.

8. A method for detecting transactional fraud, the method comprising:
in response to detecting a transaction associated with a first transaction location and account holder, requesting, from a mobile network operator, mobile location information associated with the account holder or a mobile device associated with the account holder;
receiving the mobile location information associated with the account holder; and
comparing the received mobile location information against the first transaction location to determine, at least in part, whether the transaction is fraudulent.

9. The method of claim 8 wherein requesting mobile location information associated with the account holder or a mobile device associated with the account holder comprises providing account holder information selected from the group consisting of a mobile station integrated services digital network (MSISDN) identifier, an international mobile subscriber identity (IMSI) identifier, a subscriber name, a subscriber address, or a private subscriber ID.

10. The method of claim 9 comprising translating the account holder information into identifiers recognized by the mobile network operator.

11. A system for detecting transactional fraud, the system comprising:
a mobile location information access application (MLIA) embodied in a non-transitory computer readable medium, the MLIA including:
means for obtaining mobile location information derived from data associated with a mobile communication device; and
means for providing the mobile location information to a requestor for determining whether a transaction is fraudulent.

12. The system of claim 11 wherein the data associated with a mobile communication device comprises mobility management signaling messages.

13. The system of claim 11 comprising an HLR/HSS backup, wherein the MLIA obtains the mobile location information from the HLR/HSS backup.

14. The system of claim 11 comprising a lightweight HLR/HSS that contains a subset of subscriber information contained in an HLR/HSS backup, wherein the MLIA obtains the mobile location information from the lightweight HLR/HSS.

15. The system of claim 11 comprising a presence server, wherein the MLIA provides the mobile location information to watchers who subscribe to a financial transaction participant.

16. The system of claim 15 wherein the MLIA is co-located with the presence server.

17. The system of claim 11 comprising an accounting/billing module for generating accounting data relating to the providing of the mobile location information.

18. The system of claim 11 comprising a Diameter router, wherein the MLIA is co-located with the Diameter router.

19. The system of claim 11 comprising a stand-alone monitoring platform, when the MLIA is co-located with the stand alone monitoring platform.

20. The system of claim 11 comprising an STP, wherein the MLIA is co-located with the STP.

21. The system of claim 11 wherein the transaction comprises a credit or debit card transaction.

22. A non-transitory computer readable medium having stored thereon executable instructions that when executed by the processor of a computer control the computer to perform steps comprising:
for a transaction associated with a first transaction location and account holder, receiving a request for mobile location information associated with the account holder;
obtaining mobile location information associated with the account holder, wherein the mobile location information is derived from data associated with a mobile communication device used by the account holder; and
providing the mobile location information associated with the account holder to the requestor.
